(19) United States
(12) Patent Application Publication
(10) Pub. No.: US 2020/0151734 A1
(43) Pub. Date: May 14, 2020

(54) MAINTAINING TIME-BASED SESSIONS TO FACILITATE DYNAMIC SEGMENTATION OF USERS IN AN ECOMMERCE SYSTEM

(71) Applicant: Zendesk, Inc., San Francisco, CA (US)

(72) Inventors: Jeffrey P. Theobald, Victoria (AU); Casper Szymiczek-Graley, Melbourne (AU); Cheng Ying Tang, San Francisco, CA (US)

(73) Assignee: Zendesk, Inc., San Francisco, CA (US)

(21) Appl. No.: 16/539,551

(22) Filed: Aug. 13, 2019

Related U.S. Application Data
(63) Continuation-in-part of application No. 16/370,547, filed on Mar. 29, 2019.
Application No. 16/370,547 is a continuation-in-part of application No. 16/183,756, filed on Nov. 8, 2018.
(60) Provisional application No. 62/826,545, filed on Mar. 29, 2019.

(51) Int. Cl. G06Q 30/00; G06Q 30/02

(52) U.S. Cl. CPC G06Q 30/016; G06Q 30/0204

(57) ABSTRACT

The system receives an event, which is generated during operation of an ecommerce system, wherein the event represents an action taken by a user while interacting with the ecommerce system. Next, the system determines whether the event is relevant to one or more time-based sessions for the user, wherein a time-based session is defined by a set of filter conditions and operators, which need to be satisfied for the user to be joined in an associated segment, wherein the set of filter conditions defines a time window for events. Then, for each identified relevant time-based session, the system updates the time-based session to include the event. If the update causes events in the time-based session to satisfy the set of filter conditions and operators, the system emits a segment-join event for the user to enable a downstream listener to perform an action in response to the user joining the segment.

### RELATED APPLICATION

This application is a continuation-in-part of, and hereby claims priority under 35 U.S.C. § 120 to, pending U.S. patent application Ser. No. 16/370,547, entitled “Segmenting Users and Associated Events to Provide Actionable Insights in an Ecommerce System,” by inventors Cheng Ying Tang, et al., filed on 29 Mar. 2019 (Attorney Docket No. ZEN19-1002). U.S. patent application Ser. No. 16/370,547 is itself a continuation-in-part of, and hereby claims priority under 35 U.S.C. § 120 to, pending U.S. patent application Ser. No. 16/183,756, entitled “System and Method for Classifying Events to Facilitate Storage and Retrieval in an Event-Driven Computing System,” by inventors Cheng Ying Tang, et al., filed on 8 Nov. 2018 (Attorney Docket No. ZEN18-1005). U.S. patent application Ser. No. 16/370,547 also claims the benefit under 35 U.S.C. § 119 of U.S. Provisional Application No. 62/826,545, entitled “Events” by inventor Cheng Ying Tang, filed on 29 Mar. 2019 (Attorney Docket No. ZEN19-1002PSP), the contents of all of which are incorporated by reference herein.

### BACKGROUND

### Field

The disclosed embodiments generally relate to the design of customer-support services for ecommerce systems. More specifically, the disclosed embodiments relate to a system that maintains time-based sessions to facilitate dynamic segmentation of users in an ecommerce system.

### Related Art

As electronic commerce continues to proliferate, ecommerce systems are beginning to make use of various customer-support systems to better manage interactions with their customers. These customer-support systems commonly include services that monitor user actions to facilitate various interactions with customers, and ticketing systems, which help customers resolve their problems, either by providing information to the customers, or by facilitating online interactions with customer-support agents. When designed properly, these customer-support systems can significantly improve and automate interactions with customers.

Customer-support systems are also beginning to make use of event-driven architectures. Event-driven architectures are comprised of highly decoupled event-processing modules, which asynchronously generate, receive and process event notifications. The benefit of an event-driven architecture is that it enables large numbers of event producers and event consumers to efficiently exchange information in near real-time without having dependencies or the need to be aware of one another.

Event-driven architectures can provide significant advantages in customer-support systems because they facilitate tracking activities associated with system users. For example, events can be used to tell a story about actions of a user who is interacting with an ecommerce system. This makes it possible to: upsell to the user; mitigate arising problems for the user; attract more or fewer of a specific kind of user; and influence certain types of user activity. Moreover, by storing events associated with users, it is possible to perform “segmentation operations” involving the events. For example, we may want to identify a specific subset of users that have done A, then B, and then C within a time interval t. Unfortunately, existing customer-support systems with event-driven architectures presently provide little support for performing such segmentation operations; they only provide limited mechanisms for identifying users based on specific user actions.

Hence, what is needed is an event-based customer-support system that facilitates segmenting users to provide actionable insights in an ecommerce system.

### SUMMARY

The disclosed embodiments relate to a system that dynamically segments users of an ecommerce system. During operation, the system receives an event, which is generated during operation of the ecommerce system, wherein the event represents an action taken by a user while interacting with the ecommerce system. Next, the system determines whether the event is relevant to one or more time-based sessions for the user, wherein a time-based session is defined by a set of filter conditions and operators, which need to be satisfied for the user to be joined in an associated segment, wherein the set of filter conditions defines a time window for events. Then, for each identified relevant time-based session, the system updates the time-based session to include the event, and if the update causes events in the time-based session to satisfy the set of filter conditions and operators, the system emits a segment-join event for the user to enable a downstream listener to perform an action in response to the user joining the segment.

In some embodiments, the system automatically removes events from time-based sessions as elapsing time causes events to fall outside time windows for the time-based sessions. If removing an event from a given time-based session causes events in the time-based session to no longer satisfy an associated set of filter conditions and operators, the system emits a segment-leave event for an associated user to enable a downstream listener to perform an action in response to the user leaving the segment.

In some embodiments, when a downstream listener detects a segment-join event or a segment-leave event for a user, the downstream listener can perform one or more of the following operations: sending a message to the user; sending a marketing offer to the user; and causing a customer-support representative to contact the user.

In some embodiments, the set of filter conditions and operators for a given time-based session is defined by an abstract syntax tree (AST) that specifies logical AND, OR, and NOT operations between the filter conditions.

In some embodiments, the operators for a given time-based session additionally include an AND-THEN operator, which specifies a required sequential ordering between events in the time-based session.

In some embodiments, the set of filter conditions for a given time-based session additionally specifies capture information, which identifies specific information from events to be captured and sent to downstream listeners. For example, the capture information can include a “purchased item name” or a “username.”

In some embodiments, a filter condition can be based on an aggregation of values for an event property across multiple events of the same type. For example, an aggregation can include a sum of values associated with a specific event, or a count of the number of times a specific event occurs.

In some embodiments, an event can include one of the following: a user sign-up event; a user-password-reset event; a user-login event; an add-payment-method event; a page-view event; a purchase event; an add-to-cart event; a check-out event; an add-subscription event; a rating-of-product-or-service event; and an open-support-ticket event.

In some embodiments, a filter specifies a condition associated with an event attribute for an event, wherein the event attribute can include: an event type; an occurrence of the event; an event property; an event source; and a support-ticket associated with the event.

In some embodiments, the system exposes an application programming interface (API), which enables a customer-support agent to define a time-based session by specifying an associated set of filter conditions and operators.

### BRIEF DESCRIPTION OF THE FIGURES

FIG. 1 illustrates a computing environment including an application and an associated customer-support system in accordance with the disclosed embodiments.

FIG. 2 illustrates the structure of the ticketing system in accordance with the disclosed embodiments.

FIG. 3 illustrates an associated event-driven system in accordance with the disclosed embodiments.

FIG. 4 illustrates a user segmentation service in accordance with the disclosed embodiments.

FIG. 5A illustrates an abstract syntax tree (AST) representation for a set of filter conditions and operators that define a segment in accordance with the disclosed embodiments.

FIG. 5B illustrates an exemplary segment showing how a customer enters and leaves the segment when several small items are purchased in accordance with the disclosed embodiments.

FIG. 5C illustrates another exemplary segment showing how a customer enters and leaves the segment when a small item and a large item are purchased in accordance with the disclosed embodiments.

FIG. 6 presents a flow chart illustrating operations performed while processing a new event in accordance with the disclosed embodiments.

FIG. 7 presents a high-level flow chart illustrating operations performed to facilitate dynamic segmentation in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

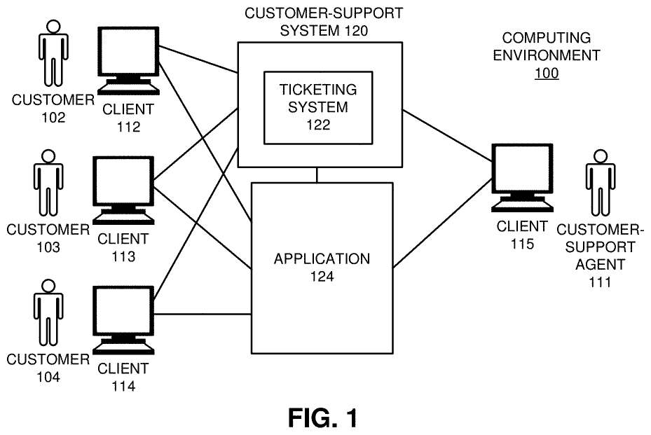

Before describing the dynamic segmentation technique further, we first describe a computing environment in which it operates. FIG. 1 illustrates an exemplary computing environment 100 in which an event-driven computing system operates. Computing environment 100 includes an application 124 and customer-support system 120. Within computing environment 100, a number of customers 102-104 interact with application 124 through client computer systems 112-114, respectively. Application 124 can be provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a customer-support system 120 to obtain help dealing with issues, which can include various problems and questions. For example, a user of accounting software may need help in using a feature of the accounting software, or a customer of a website that sells sporting equipment may need help in cancelling an order that was erroneously entered. This help may be provided by a customer-support agent 111 who operates a client computer system 115 and interacts with customers 102-104 through customer-support system 120. This help may also comprise automatically suggested helpful articles that the customer can read to hopefully resolve the problem or question. Note that customer-support agent 111 can access application 124 (either directly or indirectly through customer-support system 120) to help resolve an issue.

In some embodiments, customer-support system 120 is not associated with computer-based application 124, but is instead associated with another type of product or service that is offered to a customer. For example, customer-support system 120 can provide assistance with a product, such as a television, or with a service such as a package-delivery service.

Customer-support system 120 organizes customer issues using a ticketing system 122, which generates tickets to represent each customer issue. Ticketing systems are typically associated with a physical or virtual “help center” (or “help desk”) for resolving customer problems. Note that, although the present invention is described with reference to a ticketing system, it is not meant to be limited to customer-support interactions involving ticketing systems. In general, the invention can be applied to any type of system that enables a customer to resolve a problem with a product or service provided by an organization.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-support agents who are interacting with the customer; (4) email and other electronic communications about the problem (which, for example, can include a question posed by a customer about the problem); (5) information about telephone calls associated with the problem; (6) timeline information associated with customer-support interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-support agent. Ticketing system 122 is described in further detail below.

### Ticketing System

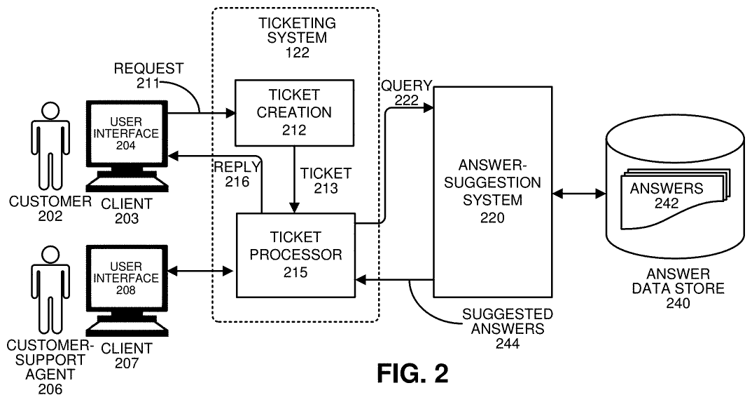

FIG. 2 illustrates a number of processes, which are associated with a ticketing system 122 and an associated answer-suggestion system 220, in accordance with the disclosed embodiments. One of the processes starts with a ticket-creation operation 212 that takes place within ticketing system 122. This ticket-creation operation 212 is triggered by actions of a customer 202 operating on a client 203 through a user interface 204 who has an issue with a product or a service, and submits a request 211 to obtain help with the issue. Note that customer 202 can submit request 211 through a number of possible channels, including through email, online forms, social networking sites, etc. In response to request 211, the ticket-creation operation 212 produces a ticket 213 that feeds into a ticket processor 215.

Next, ticket processor 215 can send a query 222, which is associated with the customer request 211 and the corresponding ticket 213, to an answer-suggestion system 220. Then, answer-suggestion system 220 obtains a set of suggested answers 244 from a set of answers 242 contained in an answer data store 240. Next, answer-suggestion system 220 returns the suggested answers 244 to ticket processor 215, which sends a reply 216 containing the suggested answers 244 to a user interface 204 to be displayed to customer 202. Note that user interface 204 can be implemented in a number of different ways for both mobile and desktop platforms. For example, user interface 204 can be incorporated into: a web page, an email, or a UI screen provided by an application.

User interface 208 operating on client 207 enables customer-support agent 206 to perform a customer-support operation in response to the customer requests. For example, the customer-support operation can include: suggesting an agent's answer or a helpful article to a customer; creating, editing or deleting an answer or article; or configuring a chatbot to facilitate resolving the customer request.

Many of the operations performed by ticketing system 122 are controlled by an event-driven architecture, which is described in more detail below.

### Event-Driven Computing System

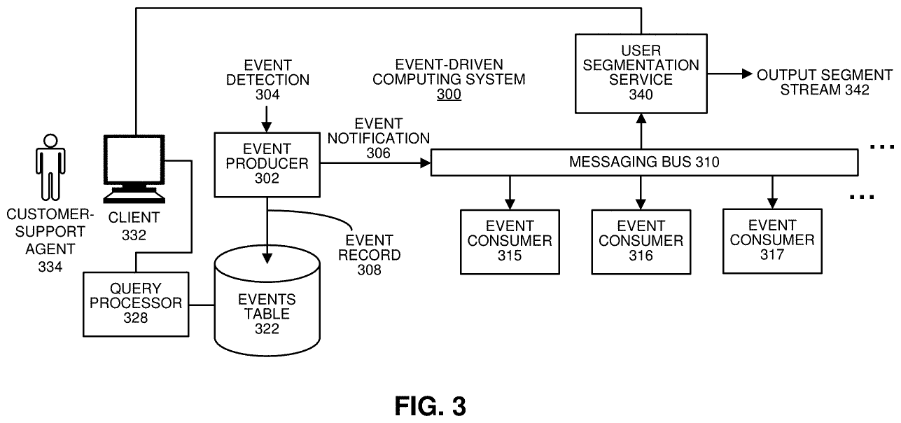

FIG. 3 illustrates an exemplary event-driven computing system 300 in accordance with the disclosed embodiments. As mentioned above, an event-driven computing system includes both event producers, such as event producer 302, and event consumers 315-317. Event producers are entities, such as applications or software modules, which detect an event, and signal that the event has occurred. Event consumers 315-317 are entities that need to know the event has occurred; they may be involved in processing the event or they may simply be affected by the event. Event consumers 315-317 typically operate by monitoring a “messaging bus” or “streaming platform,” such as Apache Kafka™ which carries event notifications generated by event producers. In general, the term “messaging bus” can refer to any type of streaming platform or bus that can carry event notifications, and is not limited to a specific streaming platform, such as Apache Kafka™.

As illustrated in FIG. 3, event-driven computing system 300 includes an event producer 302, which is a programming component that detects an event 304. (In general, the detected event can include any type of hardware-related or software-related occurrence, which can affect the execution of any component or system associated with event producer 302 and event consumers 315-317.) In response to the event detection 304, event producer 302 writes an event record 308, to an events table 322. Event producer 302 also writes a corresponding event notification 306 to a messaging bus 310. The published event notification subsequently propagates through messaging bus 310, which enables it to be received by event consumers 315-317.

Event-driven computing system 300 also supports query operations involving events. As illustrated in FIG. 3, a query processor 328 can perform various queries on events located in events table 322, for example to facilitate segmentation operations associated with the events. Results of these query operations can be presented to a customer-support agent 334 through a client 332.

Event-driven computing system 300 also includes a user segmentation service 340, which facilitates dynamic segmentation of users in accordance with the disclosed embodiments. During operation, user-segmentation service 340 receives an event stream from messaging bus 310, and processes the events in this event stream to dynamically segment users to produce an output segment stream 342 containing segmentation related events, which is directed to downstream listeners as described in more detail below. Note that the time-based sessions maintained by user segmentation service 340 can be defined through an API by a customer-support agent 334.

### User Segmentation Service

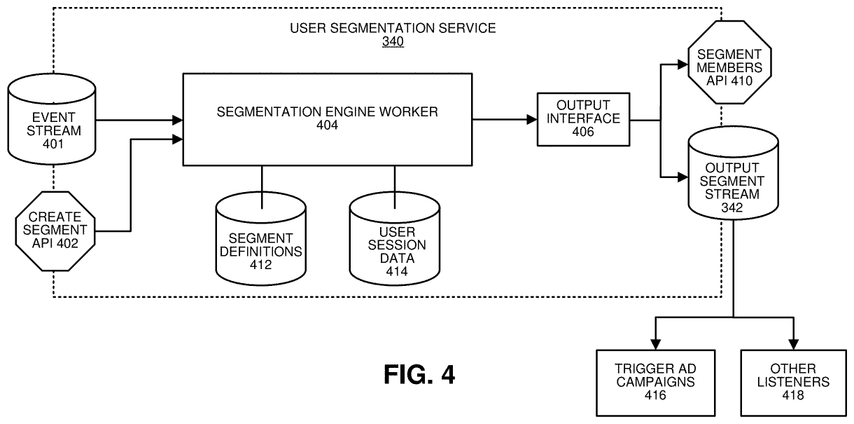

FIG. 4 illustrates the structure of an exemplary user segmentation service 340 in accordance with the disclosed embodiments. As mentioned above, user segmentation service 340 receives an event stream from messaging bus 310. This event stream 401 is directed to a segmentation engine worker 404 within user segmentation service 340, which performs dynamic segmentation operations based on the events within event stream 401 and also based on various segment definitions 412 and user session data 414. Also user segmentation service 340 exposes a “create segment API” 402, which enables a customer-support agent 334 to define time-based sessions that are used to keep track of segments by specifying associated sets of filter conditions and operators.

During operation, segmentation engine worker 404 generates various segmentation-related events, which feed through an output interface 406 to produce output segment stream 342 that feeds to downstream listeners, which can include a listener that triggers advertisement campaigns 416, as well as other listeners 418. User segmentation service 340 also exposes a segment members API 410, which can be used to obtain various information about segment members, such as determining if a specific user belongs to a specific segment, or determining how many members belong to a specific segment.

### Exemplary Segment

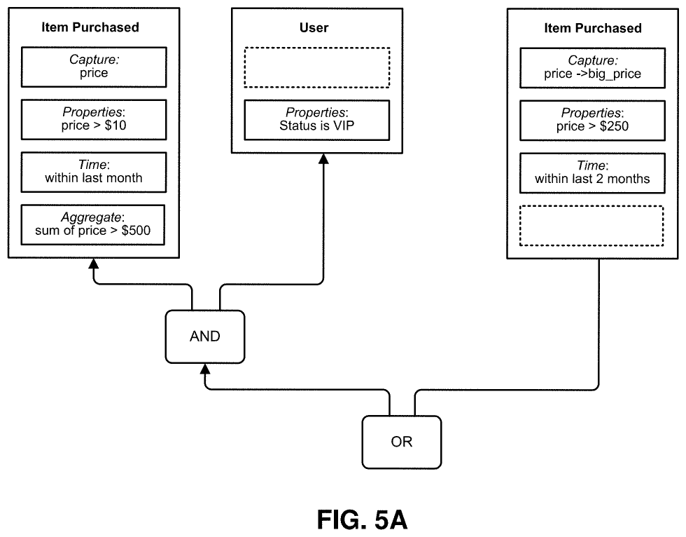

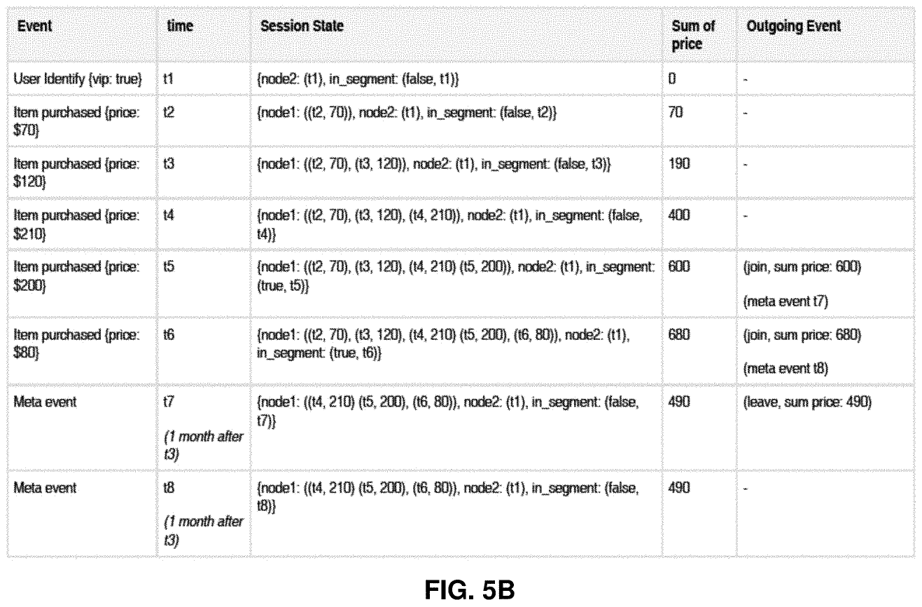

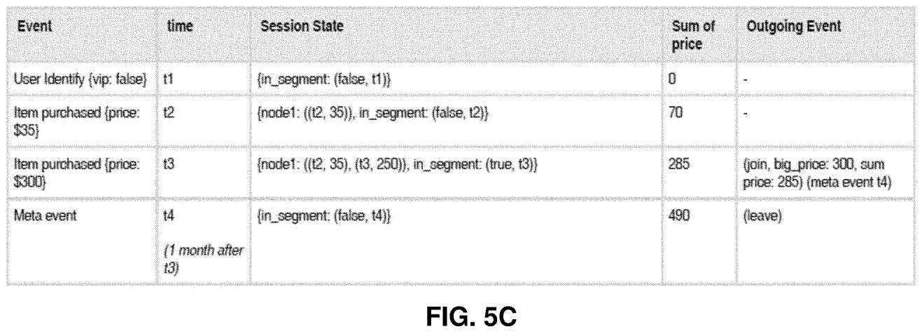

FIG. 5A illustrates an exemplary AST, which represents a segment in accordance with the disclosed embodiments. More specifically, FIG. 5A illustrates an AST for a segment that includes two types of users: (1) users who are VIPs and have made over $500 worth of purchases in the last month; and (2) users who paid over $250 for a single item in the last two months. FIG. 5B illustrates the structure of a time-based session for the case where a VIP customer enters and leaves the segment when several smallish items are purchased. In contrast, FIG. 5C illustrates a time-based session for another case where a customer enters and leaves the segment when several smallish items and one big item are purchased.

### Event Processing

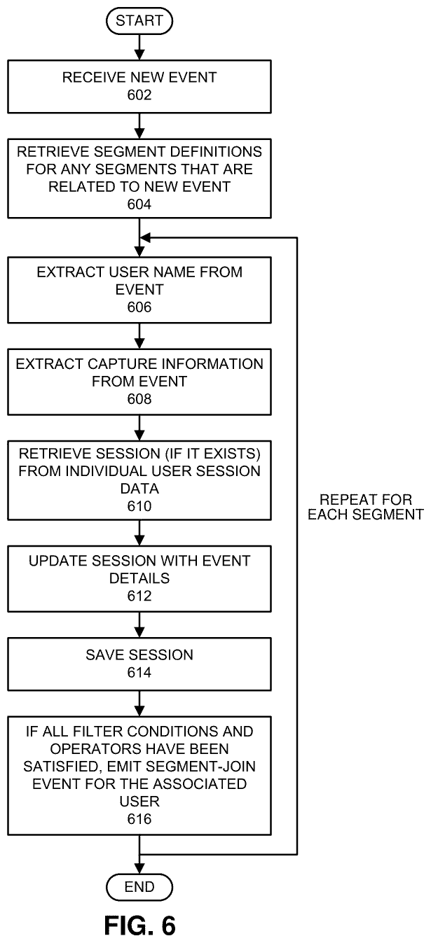

FIG. 6 presents a flow chart illustrating operations performed while processing a new event in accordance with the disclosed embodiments. At the start of this process, the system receives a new event (step 602). Next, the system retrieves segment definitions for any segments that are related to the new event (step 604). The system then repeats the following operations for each of these segments. First, the system extracts the username from the event (step 606). The system also extracts capture information from the event (step 608), wherein the capture information identifies specific information from events to be captured and sent to downstream listeners. The system then retrieves a session (if one exists) from individual user session data (step 610). Next, the system updates the session with the event details (step 612) and saves the session (step 614). Then, if all filter conditions and operators have been satisfied, the system emits a segment-join operation for the associated user (step 616).

### Dynamic Segmentation Process

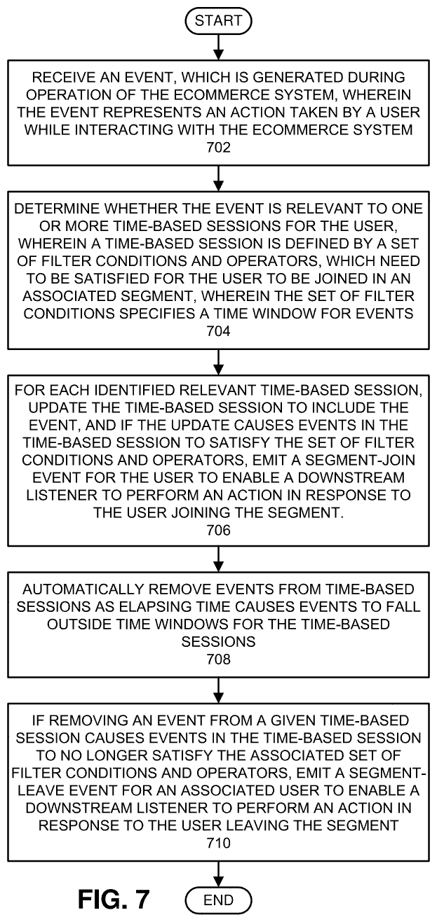

FIG. 7 presents a high-level flow chart illustrating operations performed to facilitate dynamic segmentation in accordance with the disclosed embodiments. During operation, the system receives an event, which is generated during operation of the ecommerce system, wherein the event represents an action taken by a user while interacting with the ecommerce system (step 702). Next, the system determines whether the event is relevant to one or more time-based sessions for the user, wherein a time-based session is defined by a set of filter conditions and operators, which need to be satisfied for the user to be joined in an associated segment, wherein the set of filter conditions specifies a time window for events (step 704).

As mentioned above, the set of filter conditions can include: (1) an event name, which is compulsory; (2) one or more properties (or parameters) that can be compared with specific values; (3) one or more parameters that define a time window; (4) capture information, which identifies specific information from events to be captured and sent to downstream listeners; and (5) an aggregation of values (such as a summation) for an event property across multiple events of the same type. Also, as mentioned above, the associated operators can include: AND, OR, NOT and AND-THEN operators.

Next, for each identified relevant time-based session, the system updates the time-based session to include the event, and if the update causes events in the time-based session to satisfy the set of filter conditions and operators, the system emits a segment-join event for the user to enable a downstream listener to perform an action in response to the user joining the segment (step 706). Next, the system automatically removes events from time-based sessions as elapsing time causes events to fall outside time windows for the time-based sessions (step 708). If removing an event from a given time-based session causes events in the time-based session to no longer satisfy the associated set of filter conditions and operators, the system emits a segment-leave event for an associated user to enable a downstream listener to perform an action in response to the user leaving the segment (step 710).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for dynamically segmenting users of an ecommerce system, comprising:
receiving an event, which is generated during operation of the ecommerce system, wherein the event represents an action taken by a user while interacting with the ecommerce system;
determining whether the event is relevant to one or more time-based sessions for the user, wherein a time-based session is defined by a set of filter conditions and operators, which need to be satisfied for the user to be joined in an associated segment, wherein the set of filter conditions defines a time window for events; and
for each identified relevant time-based session,
updating the time-based session to include the event, and
if the update causes events in the time-based session to satisfy the set of filter conditions and operators, emitting a segment-join event for the user to enable a downstream listener to perform an action in response to the user joining the segment.

2. The method of claim 1, wherein the method further comprises:
automatically removing events from time-based sessions as elapsing time causes events to fall outside time windows for the time-based sessions; and
if removing an event from a given time-based session causes events in the time-based session to no longer satisfy an associated set of filter conditions and operators, emitting a segment-leave event for an associated user to enable a downstream listener to perform an action in response to the user leaving the segment.

3. The method of claim 2, wherein when a downstream listener detects a segment-join event or a segment-leave event for a user, the downstream listener can perform one or more of the following operations:
sending a message to the user;
sending a marketing offer to the user; and
causing a customer-support representative to contact the user.

4. The method of claim 1, wherein the set of filter conditions and operators for a given time-based session is defined by an abstract syntax tree (AST) that specifies logical AND, OR, and NOT operations between the filter conditions.

5. The method of claim 1, wherein the operators for a given time-based session additionally include an AND-THEN operator, which specifies a required sequential ordering between events in the time-based session.

6. The method of claim 1, wherein the set of filter conditions for a given time-based session additionally specifies capture information, which identifies specific information from events to be captured and sent to downstream listeners.

7. The method of claim 1, wherein a filter condition can be based on an aggregation of values for an event property across multiple events of the same type.

8. The method of claim 1, wherein an event can include one of the following:
a user sign-up event;
a user-password-reset event;
a user-login event;
an add-payment-method event;
a page-view event;
a purchase event;
an add-to-cart event;
a check-out event;
an add-subscription event;
a rating-of-product-or-service event; and
an open-support-ticket event.

9. The method of claim 1, wherein a filter specifies a condition associated with an event attribute for an event, wherein the event attribute can include:
an event type;
an occurrence of the event;
an event property;
an event source; and
a support-ticket associated with the event.

10. The method of claim 1, wherein the method further comprises exposing an application programming interface (API), which enables a customer-support agent to define a time-based session by specifying an associated set of filter conditions and operators.

11. A non-transitory computer-readable storage medium storing instructions that when executed by a computer cause the computer to perform a method for dynamically segmenting users of an ecommerce system, comprising:
receiving an event, which is generated during operation of the ecommerce system, wherein the event represents an action taken by a user while interacting with the ecommerce system;
determining whether the event is relevant to one or more time-based sessions for the user, wherein a time-based session is defined by a set of filter conditions and operators, which need to be satisfied for the user to be joined in an associated segment, wherein the set of filter conditions defines a time window for events; and
for each identified relevant time-based session,
updating the time-based session to include the event, and
if the update causes events in the time-based session to satisfy the set of filter conditions and operators, emitting a segment-join event for the user to enable a downstream listener to perform an action in response to the user joining the segment.

12. The non-transitory computer-readable storage medium of claim 11, wherein the method further comprises:
automatically removing events from time-based sessions as elapsing time causes events to fall outside time windows for the time-based sessions; and
if removing an event from a given time-based session causes events in the time-based session to no longer satisfy an associated set of filter conditions and operators, emitting a segment-leave event for an associated user to enable a downstream listener to perform an action in response to the user leaving the segment.

13. The non-transitory computer-readable storage medium of claim 12, wherein when a downstream listener detects a segment-join event or a segment-leave event for a user, the downstream listener can perform one or more of the following operations:
sending a message to the user;
sending a marketing offer to the user; and
causing a customer-support representative to contact the user.

14. The non-transitory computer-readable storage medium of claim 11, wherein the set of filter conditions and associated filter conditions for a given time-based session is defined by an abstract syntax tree (AST) that specifies logical AND, OR, and NOT operations between the filter conditions.

15. The non-transitory computer-readable storage medium of claim 11, wherein the operators for a given time-based session additionally include an AND-THEN operator, which specifies a required sequential ordering between events in the time-based session.

16. The non-transitory computer-readable storage medium of claim 11, wherein the set of filter conditions for a given time-based session additionally specifies capture information, which identifies specific information from events to be captured and sent to downstream listeners.

17. The non-transitory computer-readable storage medium of claim 11, wherein a filter condition can be based on an aggregation of values for an event property across multiple events of the same type.

18. The non-transitory computer-readable storage medium of claim 11, wherein an event can include one of the following:
a user sign-up event;
a user-password-reset event;
a user-login event;
an add-payment-method event;
a page-view event;
a purchase event;
an add-to-cart event;
a check-out event;
an add-subscription event;
a rating-of-product-or-service event; and
an open-support-ticket event.

19. The non-transitory computer-readable storage medium of claim 11, wherein a filter specifies a condition associated with an event attribute for an event, wherein the event attribute can include:
an event type;
an occurrence of the event;
an event property;
an event source; and
a support-ticket associated with the event.

20. The non-transitory computer-readable storage medium of claim 11, wherein the method further comprises exposing an application programming interface (API), which enables a customer-support agent to define a time-based session by specifying an associated set of filter conditions and operators.

21. A system that dynamically segments users of an ecommerce system, comprising:
at least one processor and at least one associated memory; and
a segmentation mechanism, which executes on the at least one processor, wherein during operation, the segmentation mechanism:
receives an event, which is generated during operation of the ecommerce system, wherein the event represents an action taken by a user while interacting with the ecommerce system;
determines whether the event is relevant to one or more time-based sessions for the user, wherein a time-based session is defined by a set of filter conditions and operators, which need to be satisfied for the user to be joined in an associated segment, wherein the set of filter conditions defines a time window for events; and
for each identified relevant time-based session,
updates the time-based session to include the event, and
if the update causes events in the time-based session to satisfy the set of filter conditions and operators, emits a segment-join event for the user to enable a downstream listener to perform an action in response to the user joining the segment.

22. The system of claim 21, wherein during operation the segmentation mechanism also:
automatically removes events from time-based sessions as elapsing time causes events to fall outside time windows for the time-based sessions; and
if removing an event from a given time-based session causes events in the time-based session to no longer satisfy an associated set of filter conditions and operators, the segmentation mechanism emits a segment-leave event for an associated user to enable a downstream listener to perform an action in response to the user leaving the segment.

23. The system of claim 22, wherein when a downstream listener detects a segment-join event or a segment-leave event for a user, the downstream listener can do one or more of the following:
send a message to the user;
send a marketing offer to the user; and
cause a customer-support representative to contact the user.
